(19) United States
(12) Patent Application Publication
(10) Pub. No.: US 2013/0047937 A1
(43) Pub. Date: Feb. 28, 2013

(54) Retractable Vertical/Horizontal Pet Ramp With Accessed Lighting or Glow-in The Dark Lighting Strips

(71) Applicant: Rachelle Chery, Austin, TX (US)

(72) Inventor: Rachelle Chery, Austin, TX (US)

(21) Appl. No.: 13/601,659

(22) Filed: Aug. 31, 2012

Related U.S. Application Data
(60) Provisional application No. 61/529,823, filed on Aug. 31, 2011.

(51) Int. Cl. A01K 29/00

(52) U.S. Cl. 119/849

(57) ABSTRACT

The present disclosure presents a novel apparatus for and method of providing flexibility in height and width in a telescoping ramp having four (with option of more) ramp segments telescopically extendable from a compact state to an extended state, which may include, but is not limited to a pet-related device. Side rails include abutment members and apertures for preventing the segments from being separated when the pet ramp is fully extended vertically and horizontally and further includes light-emitting glow-in-the-dark strips for providing light along the side rails for the owner and pet to see while the pet is moving up and down the ramp.

### CROSS-REFERENCE TO RELATED APPLICATIONS

This is a nonprovisional application of provisional application Ser. No. 61/529,823, filed on Aug. 31, 2011, which is incorporated by reference in its entirety.

### FIELD

The present invention relates to a pet ramp, more particularly to an adjustable pet-accessed lighted telescoping pet ramp for enabling a pet to climb up and down from an elevated structure and being able to adjust the height and width as needed.

### BACKGROUND

The pet industry has become a multi-billion dollar industry due to the growing number of households with pets. Further, the relationship between owner and pet has developed into more of a familial nature. People are concerned about the quality of life for their pets and how to prevent injuries and extend the lives of their pets. Pets take part in many activities with their owners and pets come in various sizes and different levels of physical abilities. Often pets will need to climb up and down steps, enter elevated structures when traveling and in areas and vehicles that varies in height and width. This elevated structure is particularly difficult to aging, ill, overweight, and small pets. Therefore, many pet owners us steps or ramp to assist in this effort.

Most people use telescoping ramps because they can be extended. However, adjustment of the ramp's width is available. This limitation doesn't provide the owner the option to adjust it to narrow areas, such as staircases. There are some ramps that exist with accessed lighting (not for the purpose of the dog due to their keen night vision but for the owner's use) but they don't have the option of removable glow-in the dark strips or other affordable accessible lighting apparatus for ease, flexibility, and decorative purposes. Thus it can be seen that needs exist for improvements to pet ramps that are more flexible when making adjustments to the width for narrow spaces and turns in the staircase, financially more accessible due to glow-in the dark strips and other accessible lighting apparatus for night vision, decorative, and allow pets to easily climb up and down, into and out of an elevated structure. It is to the provision an improved pet ramp meeting these and other needs that the present invention is primarily directed. None of the prior art includes the combination of the elements of the present invention.

There has thus been outlined, rather broadly, the more important features of the retractable glow-in-the-dark ramp assembly in order that the detailed description thereof that follows may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. Additionally, the present invention lends itself to various automatic and potentially remotely actuated methods of use.

It is the object of the present invention to provide a new pet telescopically lighted ramp assembly which has many of the advantages of the telescopically ramps for pets mentioned heretofore and many novel features that result in a new pet retractable lighted ramp assembly which is not anticipated, rendered obvious, suggested, or even implied by any of the prior art ramps for pets, either alone or in any combination thereof.

For a better understanding of the invention, its operating advantages and the specific objects attained by its uses, reference should be made to the accompanying drawings and descriptive matter in which there are illustrated preferred embodiments of the invention.

### SUMMARY

The present invention is a telescoping pet ramp including a screen (sufficiently strong to support the animal) rolled onto a spring-loaded roller disposed within a housing of a side rail that slides and extending along lateral sides thereof. An additional rolled screen device is nested within the first side rail, wherein the first screen is telescopically coupled to the second screen and the nested side rail are telescopically coupled to each other so that the ramp is extendable vertically and horizontally for use and collapsible for transport and storage. An additional side rail without the nested screens is used to secure and lock the ramp in position once the desired width and height has been established. Additionally, the side rails have two segments, wherein the second segment of the ramp is telescopically slidable relative to the first segment between a compact position and an extended position. The side rails have abutment members/fasten points mounted thereto for preventing the side rails from being separated when the pet ramp is fully extended, the stops preferably having interlocking apertures (ex., push pins) that lock together when the ramp is fully extended, thereby providing a secure joint with improved rigidity and decreased bounce.

For the purpose of width and height adjustment, additional collapsible side rails with nested screens can be inserted and nested within each other to increase the height of the ramp and secured at a fasten point where desired height needs to be maintained. Further, clips on the rolled screens will be fastened to the detachable side rail once desired width has been established.

A mounting extension may be attached at a predetermined angle to facilitate use of the ramp between surfaces having different elevations, such as between the ground and the back of an automobile. A preferred embodiment of the ramp is a mounting extension may be fitted with one or more protrusions, such as non-skid pegs, on its bottom surface to prevent the ramp from slipping off the desired elevated surface. In one embodiment, the screens are constructed of plastic or any suitable material that can support small to large animals and light and flexible to roll out with a tread surface comprising grip tape or other frictional surface treatment, corrugations, waves, stippling, ridges, treads, and/or ribbing thereon, to provide a gripping surface for the pet's feet. The side rails are constructed from an extruded aluminum alloy or glass fiber-reinforced plastic (GFRP).

In one aspect, the present invention is a pet ramp having four nested segments within the lateral open side of the ramp that can be telescopically extended vertically and horizontally. The first and second segments extend vertically within the side rail extending along one lateral side thereof. Additionally, the other third and fourth segments which consist of the rolled screens are nested within the lateral side and can be extended horizontally. The side rails have abutment members mounted thereto. The detachable side rails with openings to have the apertures located on the open side of the segments slide and lock into place once the ramp is secured to the height and width chosen.

In a further aspect, the present invention provides a removable reflective strip attached by Velcro alongside the rails formed of a transparent material, such as plastic or synthetic rubber, with photoluminescent or phosphorescent colored pigment homogeneously dispersed within and incorporated into the elastometric material. The preferred photoluminescent is strontium oxide aluminate or strontium barium aluminate, which emit a yellow-green light. This particular feature is not limited and can include other versions of lighting, including accessed lighting.

These and other aspects, features and advantages of the invention will be understood with reference to the drawing figures and detailed description herein. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. For a more complete understanding of the present disclosure, and the advantages thereof, reference is now made to the following brief descriptions, which are to be taken in conjunction with the accompanying FIGUREs, in which like reference numerals indicate like features.

FIG. 1 is a top view of one embodiment of a pet ramp according to embodiments of the invention.

FIG. 2 is a side view of a pet ramp in operation disposed on a flight of stairs according to embodiments of the invention.

FIG. 3 is a side cross-section view of a pet ramp according to embodiments of the invention.

FIG. 4 is a perspective view of a collapsed pet ramp according to embodiments of the invention.

FIG. 5 is a top view of a side rail according to embodiments of the invention.

### DETAILED DESCRIPTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Those with skill in the art will recognize that the disclosed embodiments have relevance to a wide variety of areas in addition to those specific examples described below.

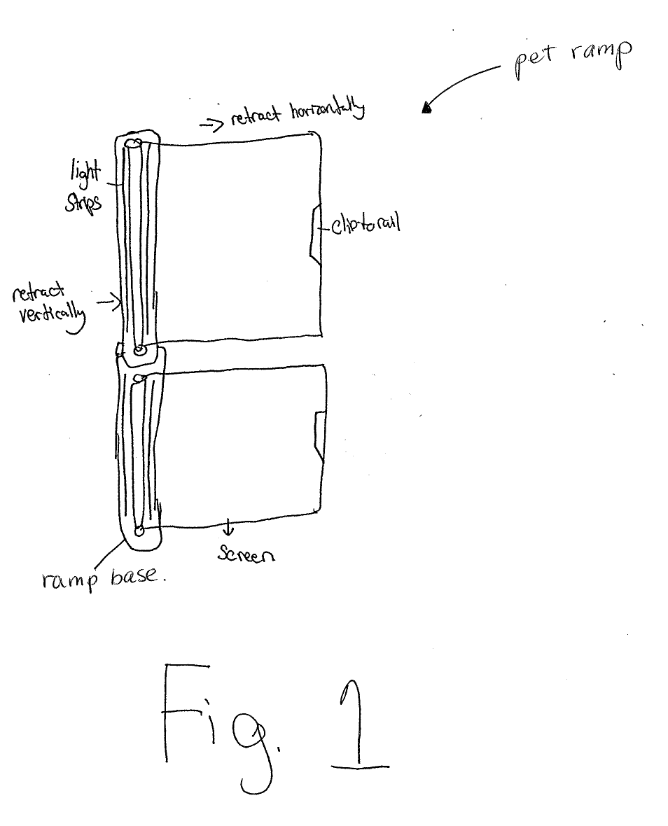

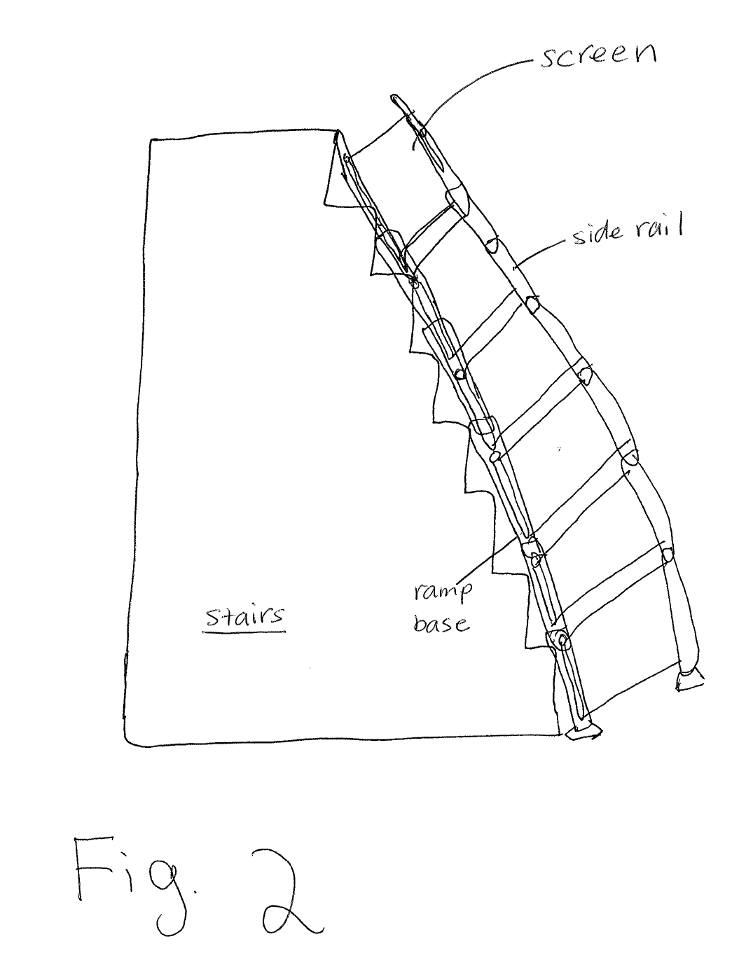

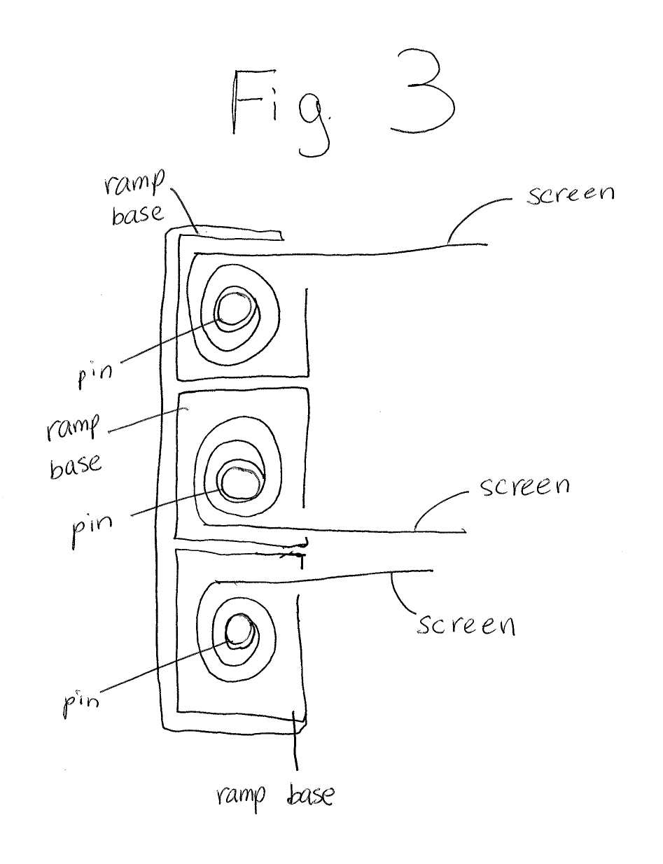

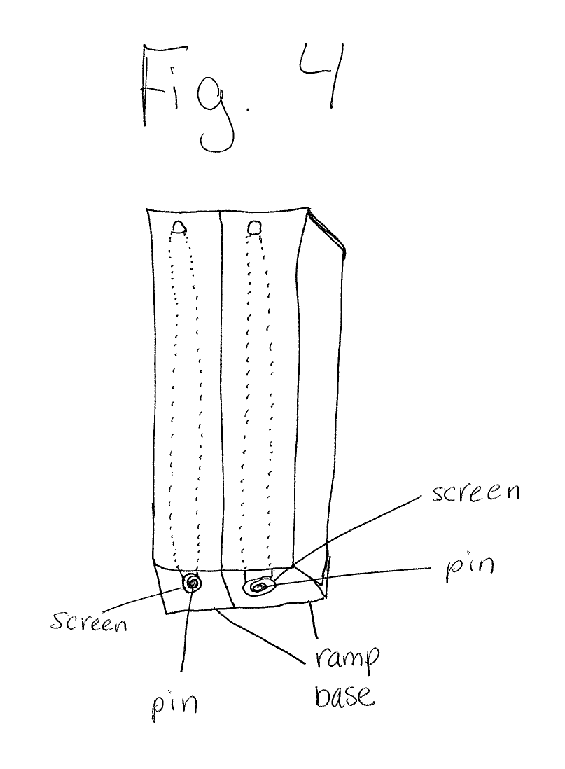

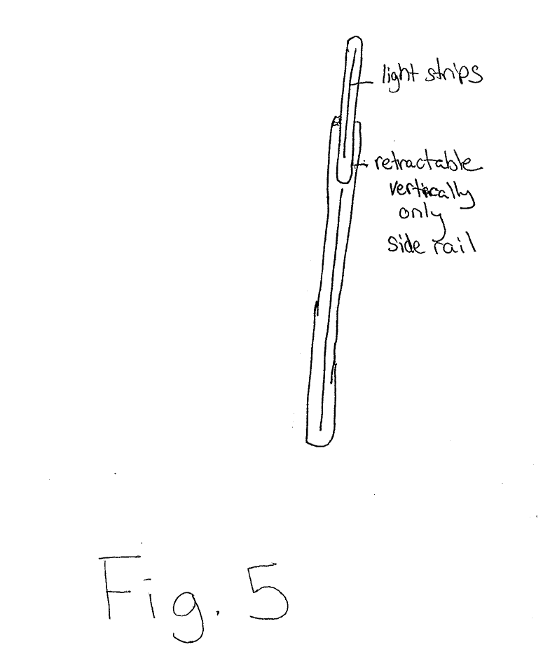

With reference now to the drawing figures, FIGS. 1-5 show a telescoping vertically and horizontally pet ramp according to an example embodiment of the present invention. The pet ramp of the present invention can be used to allow pets to climb up or down to enter or exit a car, truck, boat, staircases, or other vehicles. The ramp can also be used for humans, wherein an infant needs to climb up or down, such as a bed, couch or other upper support surface. In example forms, the telescoping pet ramp is about 70 inches fully extended and about 42 inches fully compacted. Other lengths can be produced to meet the specific needs and desires of a particular user or application and can range from 12 inches or less, to more than 100 inches fully extended and at least 3 inches to 12 inches by width.

While the invention has been described with reference to preferred and example embodiments, it will be understood by those skilled in the art that a variety of modifications, additions and deletions are within the scope of the invention.

In one embodiment, an aspect of the invention may be practiced using one or more of the exemplary parts or elements:
Pet Ramp Specs
Subsystems/Features
Tube Side Vertical Slide/Lock
Ball Bearing Slide
Prismatic Joint
Spring Loaded Pins for Locking
horizontal Pull-Out
Mechanism
Rolling/Tension
Spring Loaded Roller Blind
Clamps/Clips
Collapsible Support Bars
Lock to Rail
Clips/Hooks
Already attached
Material
Polyester (same as blinds)
Vinyl
Rubber Tread
Wire Mesh (Top or Bottom)
Nylon
Kevlar
Or Polyester base with other material glued on
Ground Contact (Floor/Bed/Car/etc)
Rubber Legs
Swivel
Fixed
Mounting Bracket
Car
Stairs
Railing Hook
Wall Mount
Rail Lock
Slot and pin
Screw/Nut
Same as Tube Side
Lighting/Reflectivity
LED
Tape
SRA
Paint
Material
Further Considerations
Cost
Complexity
Size Constraints

What is claimed is:

1. A pet ramp device comprising:
a ramp base for housing a retractable mechanism, said retractable mechanism disposed in said ramp base;
a pin disposed in the retractable mechanism for coiling or extending a screen, said screen being coiled or extended laterally from the retractable mechanism; and
wherein said pet ramp device having light strips for illuminating said pet ramp device.

2. The pet ramp device of claim 1, wherein the screen comprises a clip at a distal end thereof.

3. The pet ramp device of claim 2, further comprising a detachable side rail, said detachable side rail being attachable to the screen via the clip.

4. The pet ramp device of claim 3, wherein the detachable side rail comprises light strips for illuminating said detachable side rail.

5. A pet ramp device comprising:
a ramp base for housing a retractable mechanism, said retractable mechanism disposed in said ramp base;
a pin disposed in the retractable mechanism for coiling and extending a screen, said screen being coiled or extended laterally from the retractable mechanism;
a side rail for engaging a distal end of the screen; and
wherein said pet ramp device having light strips for illuminating said pet ramp device.

6. The pet ramp device of claim 5, wherein the side rail comprises light strips for illuminating said side rail.
